(19) United States
(12) Patent Application Publication
(10) Pub. No.: US 2004/0198382 A1
(43) Pub. Date: Oct. 7, 2004

(54) GPS children locator

(76) Inventor: Hammond Wong, West Covina, CA (US)

Correspondence Address: LADAS & PARRY, 5670 WILSHIRE BOULEVARD, SUITE 2100, LOS ANGELES, CA, 90036-5679, US

(21) Appl. No.: 10/271,876

(22) Filed: Oct. 15, 2002

(51) Int. Cl. H04M 11/00; H04Q 7/20; H04M 1/00; H04B 1/38

(52) U.S. Cl. 455/456.1; 455/556.1; 455/404.1

(57) ABSTRACT

A locator device carried on or by a person, particularly a child, sends out a signal using satellite technology known as GPS—Global Positioning System. Once the child is wearing the GPS locator device, the parent, guardian, or care giver, logs onto a computer, or a cellular phone or other communication equipment with a GPS feature, and a Web page map reveals the child's location to within a few feet. The locator device also has a built-in personal identification chip in which a child's personal information is recorded. The locator device is configured as a tiny article that can be easily attached to the child's clothing and may be camouflaged in various ways so as to avoid suspicion by a kidnaper that the article contains a GPS locator device. Alternative attachment arrangements enable the user to select the optimum attachment arrangement for the type and nature of the material upon which it is to be affixed.

### REFERENCE TO DISCLOSURE DOCUMENTS

Reference is made to U.S. Disclosure Document No. 517218 recorded Aug. 27, 2002, the entire contents of which is incorporated herein by reference.

### BACKGROUND OF THE INVENTION

1. Field of the Invention

This invention relates to a system for locating persons, especially children, or objects, and in particular to a wireless communication system for use in locating and tracking persons and/or objects.

2. Brief Description of the Prior Art

According to the U.S. National Center for Missing and Exploited Children, each year between 3,200 and 4,600 non-family abductions are reported to authorities. Family abductions account for an additional 354,100 abductions annually. Obviously, the chances for successfully locating the whereabouts of a child, or for retrieving a kidnaped child, would be greatly enhanced if it were possible to know the whereabouts of the child in real time using an electronic tracking system.

Several solutions along these lines have been proposed, such as those offered by Singer et al. in U.S. Pat. No. 5,485,163, and by Wherify Wireless, Inc., 2000 Bridge Parkway, Suite 201, Redwood Shores, Calif. 94065, and found in U.S. Pat. No. 6,362,778 to Neher.

The Wherify GPS Personal Locator For Children is said to employ integrated GPS and digital wireless technologies to determine the wearer's location.

The personal locator system of the Singer et al. patent is said to comprise a portable locator unit that can be implemented in the form of a tag or ornamental bracelet. While the Singer et al. patent hypothetically foresees, with appropriate miniaturization, that the portable locator unit shown and described could be incorporated in almost any object, such as a belt, watch, or earring, there is no teaching in the patent as to how such a miniaturized device could be constructed or how it could be implemented in the object forms suggested.

While there are other technologies offering persons/object location methods, these remain mostly out of reach of the average person due to the cost prohibitive nature of the solution. Prior to the present invention, it was thought that any system incorporating a GPS receiver would, although providing accurate location information, add undesirable bulk and perhaps several hundred dollars to the materials and construction cost of the locator device. The Wherify wrist watch implementation has proven the ability to contain the necessary GPS and cellular electronic components in small enclosures. However, the wrist watch implementation remains rather bulky for need of a relatively large sized watch band connected to the “watch” face. Additionally, the large casing and emergency buttons to be pressed by a person in distress are highly visible to any observer, raising suspicion by a child abductor as to the item worn by the child.

Moreover, prior art locator devices are not easily carried by the wearer, particularly by children, or easily attached to the wearer's clothing without drawing attention to it.

Thus, there is a need in the GPS locator system art for a true more miniaturized children locator device that is low in cost and yet provides reliable and accurate child location information, while at the same time is camouflaged so as not to draw attention to itself.

### SUMMARY OF THE INVENTION

The present invention fulfills the aforementioned needs in the GPS locator system art by providing a personal location device which can inform the parents of their child's whereabouts, and which can act as either a deterrent to potential kidnappers, or at least as an aid to law enforcement authorities during their investigation in a missing child case.

The invention involves the convergence of state-of-the-art enhanced global positioning with wireless communications, and other technologies, which will empower people with the ability to locate loved ones, especially children, whenever and wherever needed.

Reference is made to what is referred to as “Snap Track Personal Location Technology”, a preferred technology for use with the present invention, offered by SnapTrack Inc., a subsidiary of Qualcom®, a Campbell, California based company. The technology is based on a thin-client Wireless Assisted GPS system and may be incorporated into cellular phones and other wireless devices.

In accordance with the invention, there is provided a GPS Children Locator Device for use in a system for locating persons, especially children, or objects, the locator device comprising an upper housing and a lower housing, and wherein the upper and lower housings comprise, respectively, first and second attachment members cooperating to permit removable attachment of the upper housing to the lower housing, and to securely capture a thin piece of material therebetween.

In another aspect of the invention, there is provided a housing unit containing all of the electronic functional components of the GPS Children Locator Device, and a separate clip. The housing unit is provided with a thin piercing pin which snap fits into the spring clip, whereby a thin sheet of material can be captured between the housing unit and the spring clip, similar to the manner of fitting an earring to a pierced ear.

In yet another aspect of the invention, there is provided a housing unit containing all of the electronic functional components of the GPS Children Locator Device, with a pin hinge fixed to one side of the housing unit, and a pin-lock mechanism fixed to the opposite side of the housing unit. A piercing pin, after passing through a thin piece of clothing, is latched in the pin-lock mechanism.

More specifically, the present invention is directed to a locator device, carried on or by a person - particularly a child, which sends out a signal using wireless communication technology in combination with satellite GPS (Global Positioning System) technology. Once the child is wearing the GPS locator device, the parent, guardian, or care giver, logs onto a computer or cellular phone with a GPS feature having a wireless network, and a Web page map reveals the child's location to within a few feet. The locator device also has a built-in personal identification chip in which a child's personal information is recorded. The same personal ID information is also recorded in the Personal Assistant Link Center of the GPS Children Locator System. The locator device is configured as a tiny electronic component that can be easily attached to the child's clothing and may be camouflaged in various ways so as to avoid suspicion by a kidnaper that the article contains a GPS locator device.

Importantly, the GPS Children Locator Device is wearable by children of all ages, while prior art products have certain limitations on the child's age. Wherify's watch, for example, is not suitable for smaller children.

### BRIEF DESCRIPTION OF THE DRAWING

These and other aspects of the invention will be better understood, and additional features of the invention will be described hereinafter having reference to the accompanying drawings in which:

FIG. 1 is a perspective view of the GPS Children Locator Device;

FIG. 2 is an exploded perspective view of the components making up the upper housing of the GPS Children Locator Device, as seen from a position slightly above the upper housing;

FIG. 3 is an exploded perspective view of the components making up the upper housing of the GPS Children Locator Device, as seen from a position slightly below the upper housing;

FIG. 4 is a perspective view of the lower housing, as seen from the upper side of the lower housing;

FIG. 5 is a an exploded perspective view of the lower housing, as seen from the underside of an inverted lower housing, and showing a decorative object that may be attached to the underside to serve as a camouflage cover;

FIG. 6 is a cross sectional view of a first embodiment of a lower housing showing the major internal components;

FIG. 7 is a cross sectional view of a first embodiment of an upper housing showing the major internal components;

FIG. 8 is a view similar to that of FIG. 6, showing the relationship of the lower housing relative to a thin piece of material to which the GPS Children Locator Device is to be affixed;

FIG. 9 is a cross sectional view showing the upper and lower housings, from FIGS. 6 and 7, respectively, prior to being coupled together, with a thin piece of material sandwiched therebetween;

FIG. 10 is a cross sectional view showing the upper and lower housings, from FIGS. 6 and 7, respectively, after being coupled together, with a thin piece of material sandwiched therebetween;

FIG. 11A is a partial cross sectional view showing the left half of assembled upper and lower housings constructed according to a second embodiment of the invention, in a standby, or normal, mode of the GPS Children Locator Device;

FIG. 11B is a partial cross sectional view showing the right half of assembled upper and lower housings constructed according to the second embodiment of the invention, in a normal, or standby, mode of the GPS Children Locator Device;

FIG. 12A is a partial cross sectional view showing the left half of assembled upper and lower housings constructed according to the second embodiment of the invention, in an emergency, or active, mode of the GPS Children Locator Device;

FIG. 12B is a partial cross sectional view showing the right half of assembled upper and lower housings constructed according to the second embodiment of the invention, in an emergency, or active, mode of the GPS Children Locator Device;

FIG. 13 is a general schematic block diagram showing the interconnection of the main functional electronic components of the GPS Children Locator Device;

FIG. 14 is a line drawing of a piece of clothing showing how the GPS Children Locator Device may be attached to a child's clothing in a manner not to raise suspicion as to its actual purpose and function;

FIG. 15 is a pictorial representation of the complete GPS Children Locator System showing the participants, electronic apparatuses, and transmission paths involved and in place while in a normal, or standby, mode;

FIG. 16 is a pictorial representation of the complete GPS Children Locator System showing the participants, electronic apparatuses, and transmission paths involved and in place while in an emergency, or active mode;

FIG. 17 is a perspective view of another embodiment of the invention showing a single housing containing all of the functional electronic components of the GPS Children Locator Device, and a first alternate embodiment of an attachment arrangement;

FIG. 18 is a perspective view of yet another embodiment of the invention showing a single housing containing all of the functional electronic components of the GPS Children Locator Device, and a second alternate embodiment of an attachment arrangement; and

FIG. 19 is a perspective view of a backpack upon which an embodiment of the invention such as those shown in FIGS. 17 or 18 is secured.

### DETAILED DESCRIPTION OF THE PREFERRED EMBODIMENTS

### DEFINITION OF TERMS

For the purposes of this description, the following definitions are provided.

“GPS” is an acronym for Global Positioning System, a system of satellites, computers, and receivers that is able to determine the latitude and longitude of a receiver on Earth by calculating the time difference for signals from different satellites to reach the receiver. Developed and operated by the U.S. Defense Department, the global positioning system (GPS) is a radio-navigation system consisting of a 24-satellite constellation. Using precise location and timing signals emitted by these satellites, GPS permits land, sea and airborne users to determine their three-dimensional position, velocity and time 24 hours a day, in all weather. GPS works anywhere in the world, providing location with a precision and accuracy far better than any other radio navigation system.

“SnapTrack” refers to wireless Personal Location Technology based upon a thin-client Wireless Assisted GPS system and may be incorporated into cellular phones, pagers, personal digital assistants, and other wireless devices. The SnapTrack system either runs as software on the handset's own digital signal processing (DSP) chip or as a tightly integrated enhanced GPS capability at the baseband chip level.

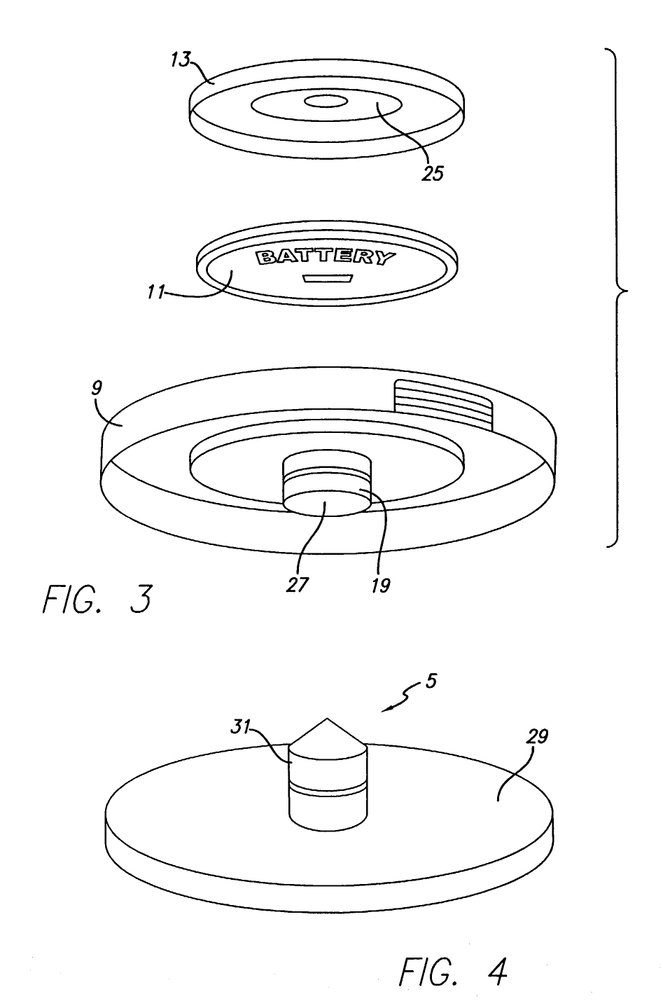

It will be understood that the use herein of the terms “upper housing” and “lower housing” is for convenience of description only, and the two terms may be considered to be interchangeable, depending on the desires of the designer or manufacturer, or the way the children wear them. Clearly, the configuration and contents of the two housings can be reversed without departing from the intended construction or installation of the GPS Children Locator Device. For example, the pin-like projection 31 (FIG. 4) can just as easily be part of the upper housing, and the receptacle 19 (FIG. 3) would then be part of the lower housing. Similarly, at the discretion of the designer or manufacturer, any of the electronic component parts of the invention can be housed in either the upper housing 3 or the lower housing 5 interchangeably, in order to optimize available space within the two housings 3 and 5, or to minimize the number and lengths of current carrying interconnections. As an example, either or both of the GPS receiver & wireless module 37 and the antenna 39 (FIG. 6) may be contained inside of upper housing 3, and the lower housing 5 can simply be a camouflage component.

It will also be understood that the figures and description herein, directed to a preferred implementation of the invention as a GPS Children Locator Device, are equally applicable to an adult person locator, or an object locator, or a pet locator.

FIG. 1 is a perspective view of the GPS Children Locator Device 1 comprising a top housing 3, a lower housing 5, and constructed and assembled in a manner to leave a gap 7 between the two housings 3 and 5, for the placement of a thin piece of material such as a piece of clothing worn by the wearer, e.g., a child in the preferred application of the invention.

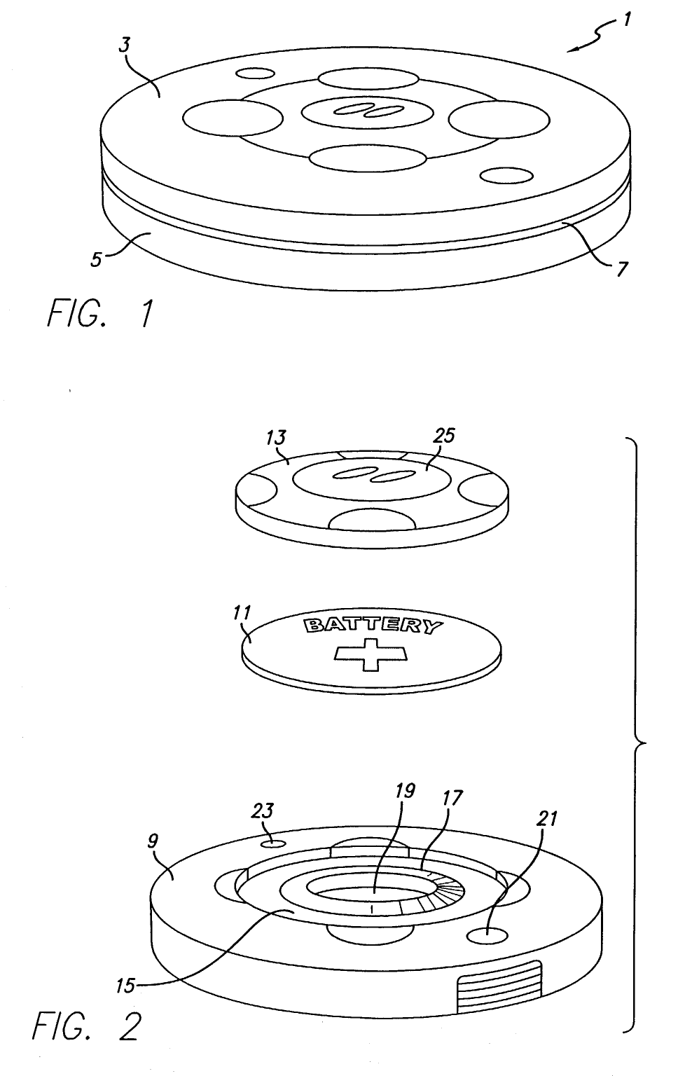

FIG. 2 is an exploded perspective view of the components making up the upper housing 3 (FIG. 1) of the GPS Children Locator Device 1, as seen from a position slightly above the upper housing and looking downwardly.

The upper housing 3 is comprised of three major components, a battery housing 9, a (preferably rechargeable) battery 11, and a cap 13 attachable to and supported by the battery housing 9.

The battery housing 9 is shown to comprise a battery cavity 15 for receiving the battery 11, battery contact circuitry 17 (shown schematically), a receptacle 19, a battery level indicator 21, and a pin-lock indicator 23, all of which will be described as to function and construction in detail hereinafter.

FIG. 3 is an exploded perspective view of the components making up the upper housing 3 (FIG. 1) as seen from a position slightly below the upper housing, revealing the generally cylindrical shape of the receptacle 19 and an opening 27 therein.

FIG. 4 is a perspective view of the lower housing 5, as seen from a position slightly above the lower housing 5 and looking downwardly. The main structural components of the lower housing 5 are a base 29 and a pin-like projection 31, hereinafter referred to as a pin 31, both of which will be further described as to function and construction, with reference to more detailed illustrations.

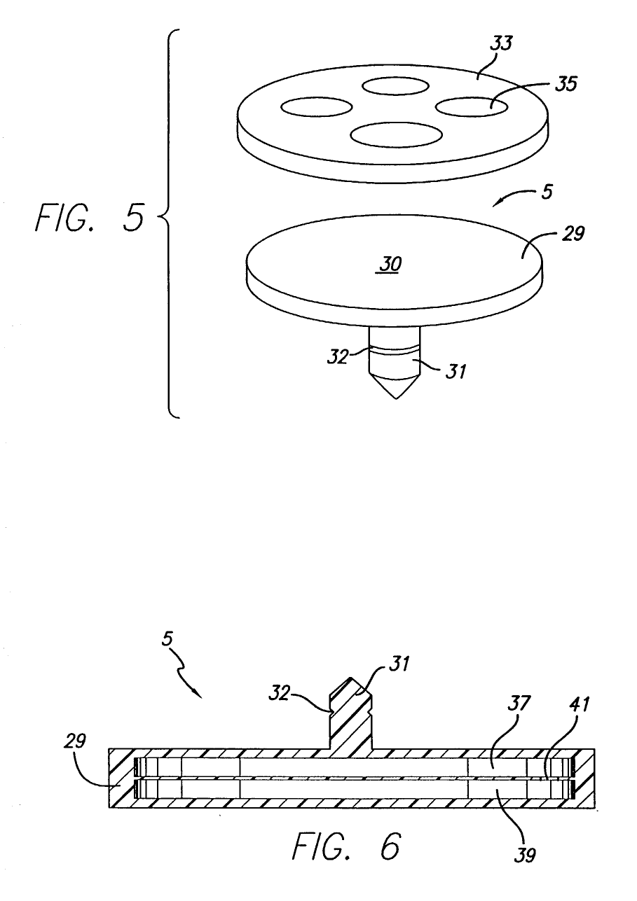

FIG. 5 is a perspective view of the underside of the lower housing 5 (inverted in the figure), additionally showing a camouflage cover 33 which may be attached to the underside of base 29 to camouflage the lower housing 5 so as not to draw attention to it. In the example of FIG. 5, the camouflage cover 33 is in the form of a button with simulated button holes 35. Alternatively, the camouflage cover 33 may exhibit a design, or it may be covered with a material color matched to the child's clothing, or it may be concealed by affixing a picture or a relief representation of a child's favorite cartoon character, and the like. The means for attaching a camouflage cover 33 to the underside 30 is left to the discretion of the designer/manufacturer.

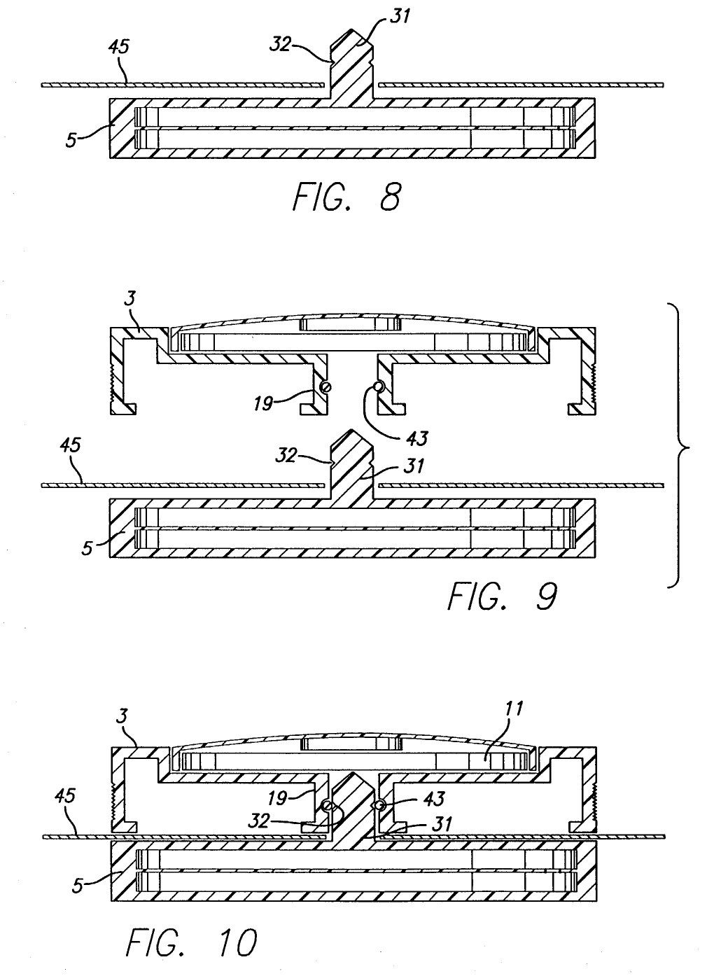

FIG. 5 also shows an annular groove 32 intermediate the ends of pin 31. Groove 32 is part of a securing arrangement for locking the upper housing 3 with the lower housing 5, to be described in connection with FIGS. 8-10.

FIG. 6 is a cross sectional view of a first embodiment of a lower housing 5 showing the major internal components housed in the base 29, a GPS receiver & wireless module 37, and an antenna 39 coupled to the GPS receiver & wireless module 37 by a connector 41.

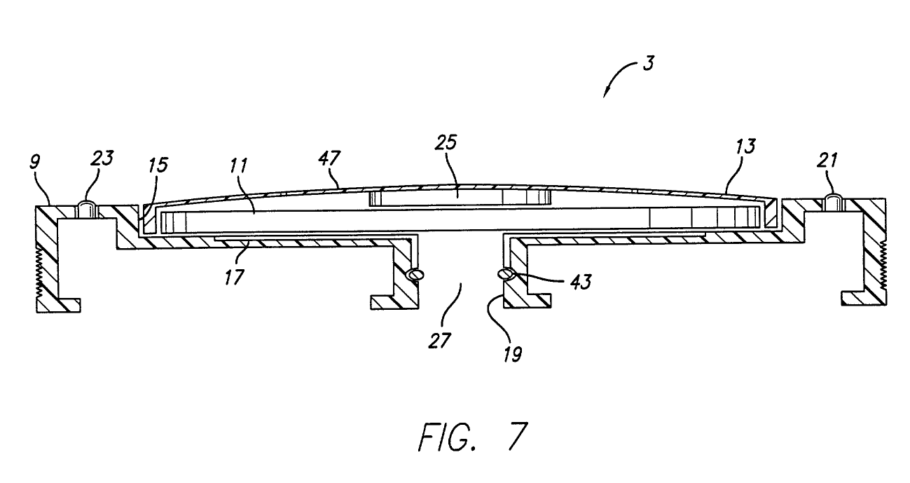

FIG. 7 is a cross sectional view of a first embodiment of an upper housing 3, showing the major internal components. Specifically, this figure shows the battery housing 9 having a battery cavity 15 for receiving a battery 11, the bottom battery terminal of which is in electrical contact with the battery contact circuitry 17 shown schematically arranged in the battery housing cavity 15. The battery contact circuitry 17 is seen to turn downwardly in the opening 27 of receptacle 19, in order to be electrically coupled to an inserted pin 31.

An emergency button & microphone arrangement 25 is affixed to the underside of cap 13 at its center. The cap 13 supports the arrangement 25 suspended above and spaced from battery 11. The cap 13 itself may be sufficiently thin so as to flex by pushing down on its center at the location of the emergency button & microphone arrangement 25, or the outer rim of cap 13 may be relatively rigid, and the center 47 may be made of flexible synthetic plastic or rubber material. In either case, the center 47 is pushed down until the bottom of the arrangement 25 contacts the top terminal of battery 11. As will be explained, this action activates the GPS receiver & wireless module 37, permitting GPS location information, together with audio sounds picked by the microphone portion of arrangement 25, to be transmitted via a wireless communications network to a wireless receiver.

This figure also shows a resilient clip 43 which resiliently accepts the pin 31 (FIG. 6) and snaps into groove 32 to releasably retain pin 31 in receptacle 19.

FIG. 8 is a view similar to that of FIG. 6, showing the relationship of the lower housing 5 relative to a thin piece of material 45. The pin 31 can either pierce the material 45 or be inserted into a button hole or other opening in the child's clothing. Alternatively, the pin 31 can be inserted into a belt buckle hole or an existing or formed hole in the child's back pack, or the like.

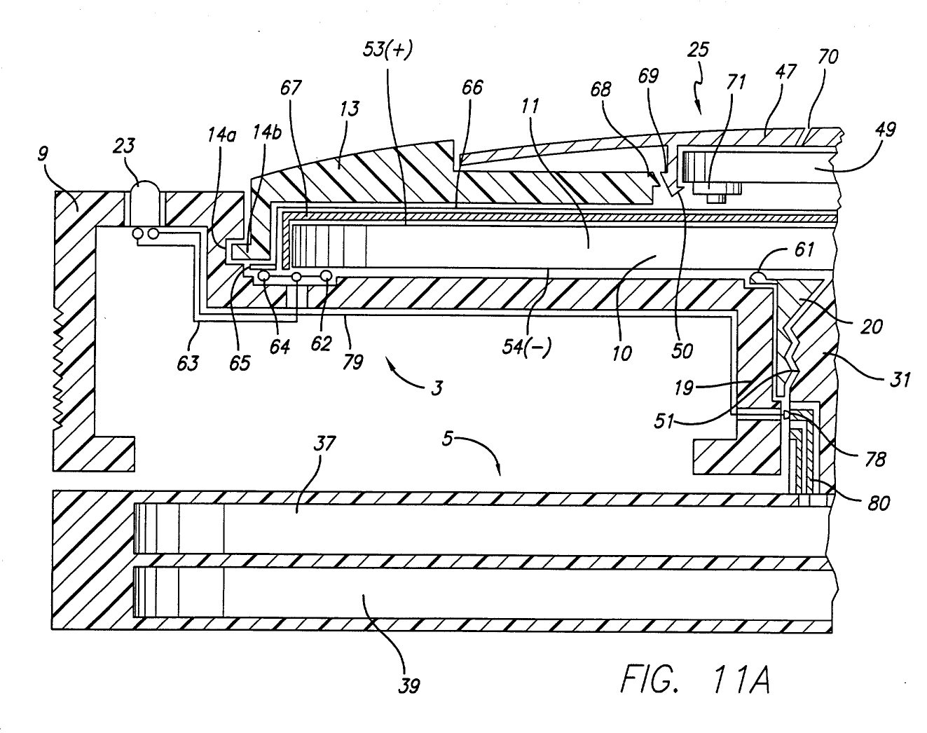

FIG. 9 is a cross sectional view showing the upper and lower housings 3 and 5 from FIGS. 6 and 7, respectively, prior to being coupled together, with the thin piece of material 45 sandwiched therebetween.

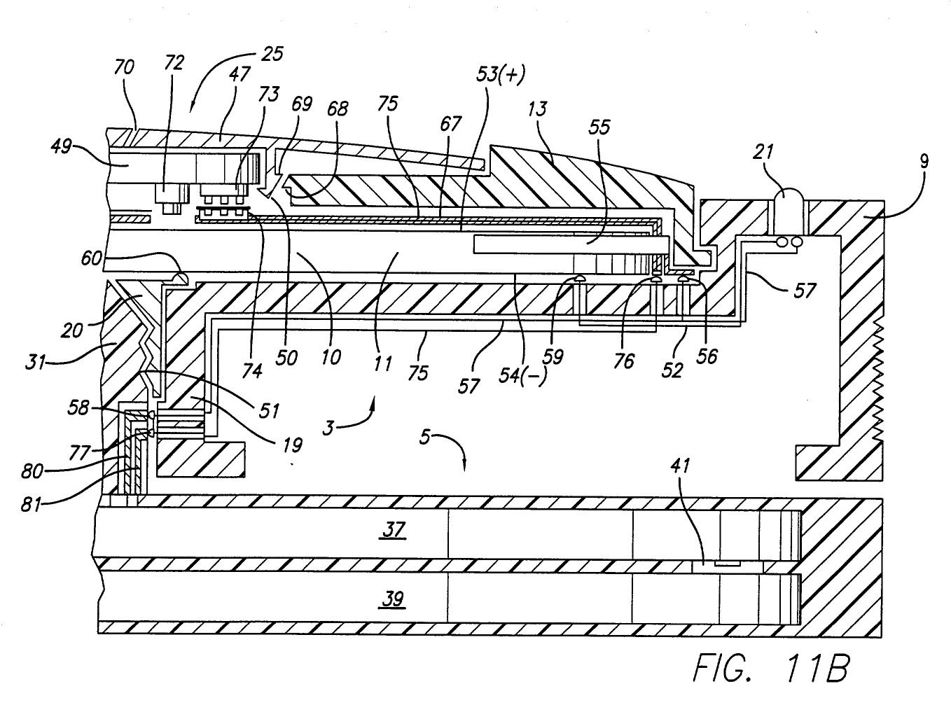

FIG. 10 is a cross sectional view showing the upper and lower housings 3 and 5 from FIGS. 6 and 7, respectively, after being coupled together, with the thin piece of material 45 sandwiched therebetween. In this view, the locking together of the upper and lower housings 3 and 5 is seen to be releasably secured by the action of the internal spring clip 43 in receptacle 19 being seated in groove 32 of pin 31. The distal end of the pin 31 is seen to touch the bottom of battery 11 which at least partially closes the opening in receptacle 19 and may function as a stop for the free distal end of pin 31, limiting the extent the pin 31 can enter the receptacle19, thereby positioning the pin 31 at a predetermined axial position relative to the opening in receptacle 19.

FIGS. 11A and 11B are, respectively, left and right side partial cross sectional views of assembled upper and lower housings 3 and 5, respectively, constructed according to a second embodiment of the invention. In these figures, the GPS Children Locator Device is in a normal, or standby, mode.

In this embodiment, cap 13 is constructed of a rigid plastic material, and button 47 is preferably made of a flexible synthetic plastic or rubber.

Emergency & microphone arrangement 25 is retained under the center of the emergency button 47 by an attachment arrangement 50. In the normal mode, the emergency button & microphone arrangement 25 are suspended over the battery 11 by the emergency button 47 portion of cap 13, and therefore no battery power is routed to the arrangement 25.

However, in the normal mode, the battery level indicator 21, the pin-lock indicator 23, and the GPS receiver & wireless module 37 are supplied with battery power.

Preferably, battery level indicator 21 and pin-lock indicator 23 have dual illuminating LEDs which can emit either green or red color light. Such LEDs are well known in the industry and can additionally comprise microchips within the LED housing which control the operation of the LEDs upon the application of power to them, an example being an LED device which continuously blinks on and off when power is applied and which is available from any Radio Shack® electronics store. For the present invention, the microchips (not shown) in indicators 21 and 23 control the respective internal LEDs as follows.

Upon insertion of a battery 11 in battery housing 9, a green LED lights in battery level indicator 21 to indicate a fully charged battery. After 5 seconds, the green LED will go out to conserve battery energy. When the battery voltage falls below an acceptable threshold level, a red LED lights and remains lit until the battery 11 is drained, alerting the user that the battery needs to be recharged or replaced.

Upon connecting the upper housing 3 to the lower housing 5, a green LED lights in the pin-lock indicator 23 to indicate that the two housings 3,5 are securely connected together. After 5 seconds the green LED will go out to conserve battery energy. When the housings 3,5 are disengaged, the green LED will go out for lack of an conductive path to the battery through the pin 31 of the lower housing 5. For example, if the external threads 51 of pin 31 have not been fully screwed into the internal threads of the receptacle insert 20 to be at a predetermined axial position, the pin-lock indicator 23 will not light.

The top 53 and sidewall 10 of the battery 11 is the (+) terminal, and the bottom 54 is the (−) terminal. The GPS receiver & wireless module 37 receives (−) battery potential through electrical power contacts 60 and 61 being biased into electrical contact with the bottom battery terminal 54. Power contacts 60 and 61 are integrally formed with an electrical conductive receptacle insert 20 affixed to the interior of receptacle 19. Pin 31, also being electrically conductive, is coupled to the GPS receiver & wireless module 37, thereby routing battery (−) potential from the bottom of battery 11, through insert 20, on to pin 31, and finally to module 37 at the connection of pin 31 to the module 37, as shown.

The GPS receiver & wireless module 37 receives (+) battery potential from the sidewall 10 (FIG. 11B) of battery 11 through electrical power contact spring strip 55, through conductor strip contact 56, over (+) power line 57, and on to (+) power receptacle contact 58. With pin 31 in full locked position, (+) battery power is passed from receptacle contact 58 through (+) power pin contact 80 on pin 31, and on to the GPS receiver & wireless module 37.

To power the battery level indicator 21, battery (+) power is routed directly to one side of indicator 21 from conductor strip contact 56 via (+) power line 57. Battery (−) power is supplied to the other side of indicator 21 directly from the (−) battery bottom terminal 54 through (−) battery contact 59.

The pin-lock indicator 23 will be unlit without the pin 31 fully inserted in the receptacle 19. Indicator 23 will light, for five seconds, when pin 31 is properly inserted and locked in a predetermined axial position within receptacle 19.

For power, pin-lock indicator 23 receives (−) battery potential from the battery bottom 54 through (−) power contact 62 and (−) power line 63.

As explained above, (+) power from the battery 11 exists on (+) power receptacle contact 58 at all times. However, a current path to pin-lock indicator 23 is interrupted when pin 31 is not locked in proper axial position in receptacle 19. That is, the (+) battery potential on receptacle contact 58 can pass on to receptacle contact 78 (FIG. 11A) only through pin contact 80 which extends peripherally around the body of pin 31. When pin 31 is in proper locked position, receptacle contact 78 carries (+) battery potential on to pin-lock indicator 23, thus lighting it for five seconds, as previously described.

Thus, during the respective five second intervals, a simple visual inspection of the battery level indicator 21 and the pin-lock indicator 23 will verify that the GPS Children Locator Device has enough power, has been properly installed, and is operative.

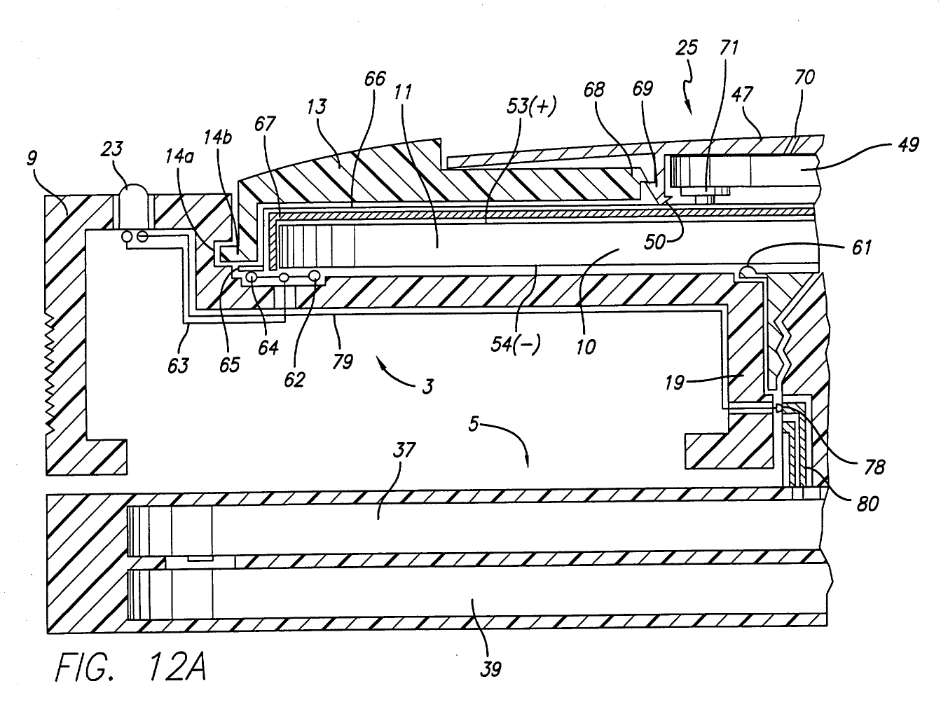

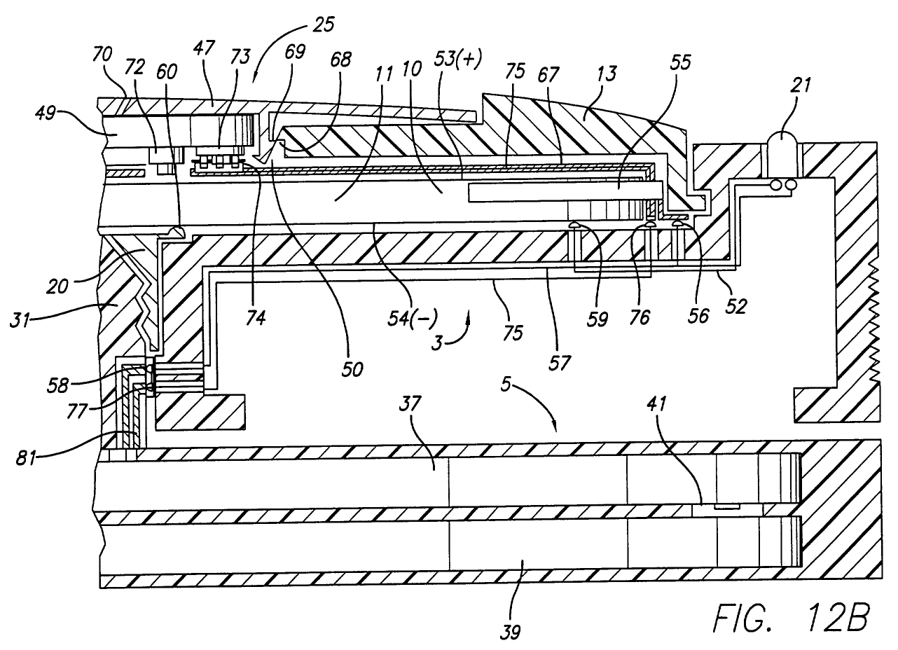

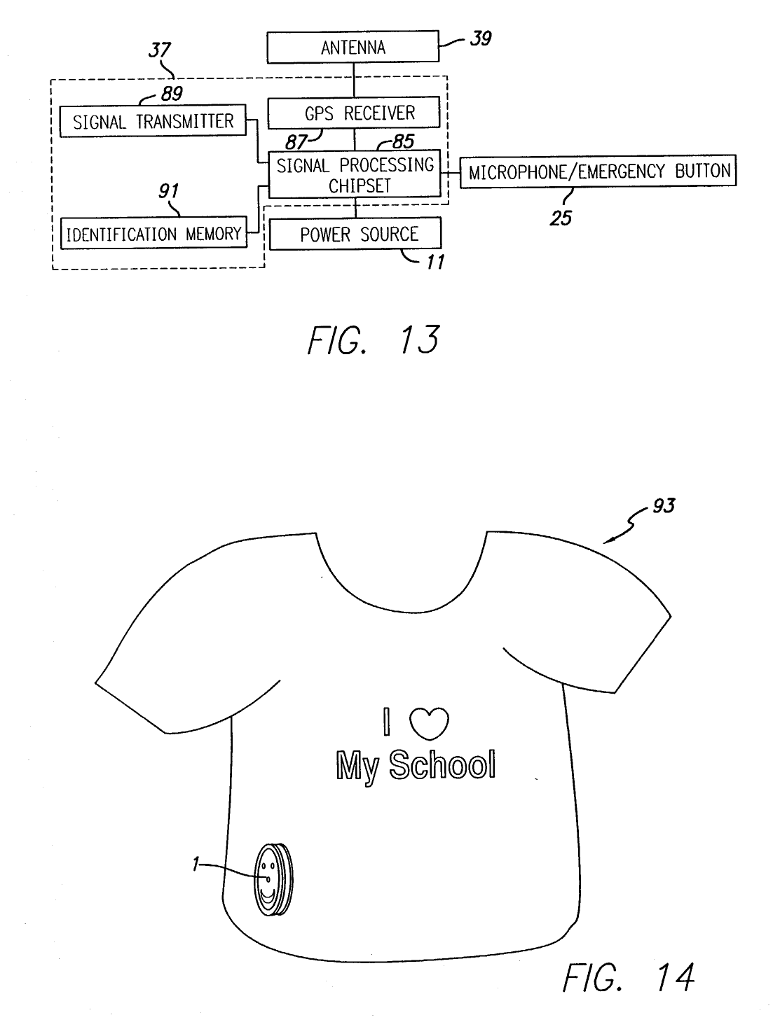

FIGS. 12A and 12B are, respectively, left and right side partial cross sectional views of assembled upper and lower housings 3 and 5 constructed according to the second embodiment of the invention. In these figures, the GPS Children Locator Device is in an emergency, or active, mode.

To place the GPS Children Locator Device 1 in the emergency mode, emergency button 47 is pressed by the child, moving the center of button 47 downwardly until the barbed end of button latch arm 69 passes the barbed cap latch projection 68 on cap 13. Latch arm 69 flexes inwardly as it passes over projection 68 and then returns to its initial position due to its plastic memory characteristics, locking the emergency button 47 in its depressed condition.

As seen in FIGS. 12A and 12B, microphone 49 has thus been lowered to effect the closing of two separate electrical contacts 71,72 providing battery power to the microphone. As described above, battery (−) potential exists on (−) power contact 62. Via power line 63, this potential is routed to (−) power contact 64 and on to microphone contact 65. The (−) microphone power lead 66 then carries the (−) battery potential on to (−) microphone contact 71.

Microphone 49 gets its (+) power supply potential by direct contact of the (+) microphone contact 72 with the top battery (+) terminal 53.

Simultaneously with the application of battery power to microphone 49, a male connector 73 on the microphone 49 contacts female connector 74, these contacts carrying the microphone audio output signal to signal line 75, through microphone line contact 76, then over a continuation of signal line 75 to microphone receptacle contact 77. When pin 31 is in operational position in receptacle 19, the microphone audio output signal is routed to microphone pin contact 81 on pin 31 and on to the GPS receiver & wireless module 37 for voice/sound transmission via antenna 39.

FIG. 13 is a general schematic block diagram showing the interconnection of the main functional electronic components of the GPS Children Locator Device. The GPS receiver & wireless module 37 contains a GPS receiver 87, a wireless signal transmitter 89, an identification memory 91, and signal processing chipset 85. Inasmuch as the operation of each of these functional blocks is well known in the art, detailed description of such functional blocks is not warranted, as a person of ordinary skill in the art will know where to procure the indicated electronic components and how to interconnect them. Similarly, a necessary antenna 39 and power source 11 are functional electronic elements quite familiar to the skilled artisan. Finally, following the illustrations in FIGS. 11A-12B, and the associated descriptive text, the manner of interconnecting a microphone/emergency button to the signal transmitter 37 under control of the signal processing chipset 85 is well known technology.

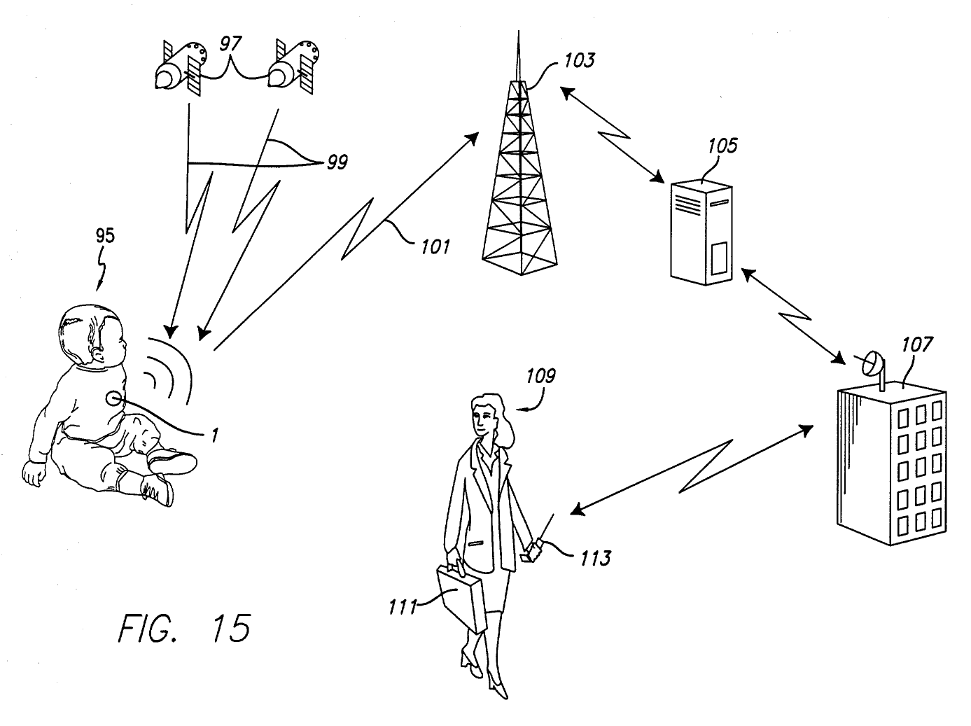

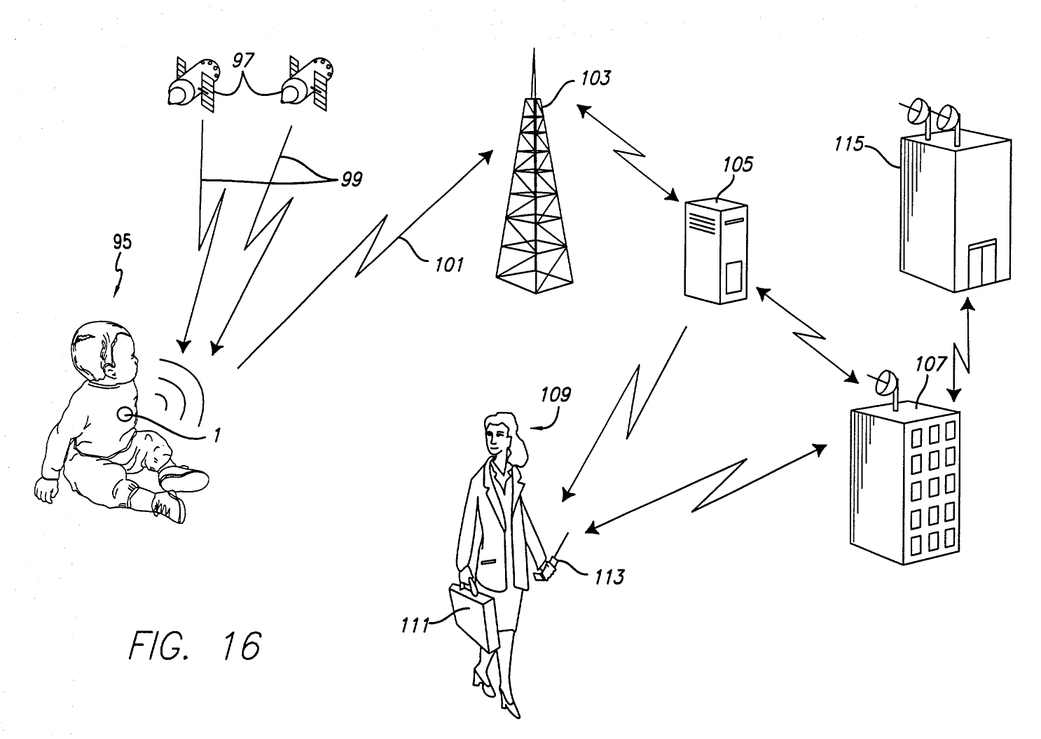

Upon sensing a microphone audio output signal, the chip set 85 indirectly senses the pushing of the emergency button & microphone arrangement 25 by the fact that the microphone output signal, which is routed to chip set 85, also acts as an emergency triggering signal. Thus, upon pushing the emergency button & microphone arrangement 25, the electronics in the GPS receiver & wireless module 37 initiates transmission of the microphone audio output signal, as well as GPS location data and personal identification data from memory 91 to a wireless communication network (FIGS. 15 and 16).

FIG. 14 is a line drawing of a piece of clothing 93 showing how the GPS Children Locator Device may be attached to a child's clothing 93, in the example shown a T-shirt, in a manner so as to not raise suspicion as to its actual purpose and function.

FIG. 15 is a pictorial representation of the complete GPS Children Locator System showing the participants, electronic apparatuses, and transmission paths involved and in place while in a normal, or standby, mode, i.e., the emergency button & microphone arrangement 25 has not been pushed.

A GPS Children Locator Device 1, worn by a child 95, continually receives GPS location signals 99 from satellites 97. These GPS signals 99 are picked up by antenna 39 (FIGS. 11A-12B) and, in the emergency mode, transmitted by signal transmitter 89 via a signal 101 to a wireless communication network 103. The wireless communication network 103 relays the location information to a location server 105 which, in turn, relays the location information to a Personal Assistant Link Center 107. The Personal Assistant Link Center 107 is in two-way communication with the parent 109 who may, depending upon his or her available communication equipment, track the whereabouts of the child 95 via the Internet using a computer 111 or by a properly equipped cellular phone 113.

In the normal mode:

1. the emergency button 47 is not pressed;

2. there is no audio transmission; and

3. the parent 109 can track the whereabouts of the child 95 through connection with Personal Assistant Link Center 107 by computer 111 via the Internet, or by cellular phone 113, or by other equipments employing GPS signals.

FIG. 16 is a pictorial representation of the complete GPS Children Locator System showing the participants, electronic apparatuses, and transmission paths involved and in place while in an emergency, or active mode, as will be described in detail.

In the emergency mode, i.e., when the emergency button & microphone arrangement 25 has been pushed and locked in the pushed condition, the system operates similar to that described in connection with FIG. 15 (normal mode), except that, in the emergency mode, the parent 109 receives GPS location data and audio via one-way communication from location server 105, and the Personal Assistant Link Center 107 of the GPS Children Locator System additionally enables two-way communication with law enforcement 115.

In the emergency mode:

1. the emergency button 47 is pressed and locked;

2. an audio signal from the microphone 49 is transmitted;

3. the parent 109 is informed immediately by the Personal Assistant Link Center 107;

4. a GPS location signal is transmitted to both the Personal Assistant Link Center 107 and the parent 109, and the Personal Assistant Link Center 107 enables two-way communication;

5. at the discretion of the parent and the Personal Assistant Link Center 107, law enforcement 115 is informed; and

6. the parent 109 may track the child 95 through connection with location server 105 or Personal Assistant Link Center 107 by computer 111 via the Internet, or by cellular phone 113, if his or her phone is installed with a GPS system, or by other equipments employing GPS signals, and may listen to the activities with his or her cellular phone 113.

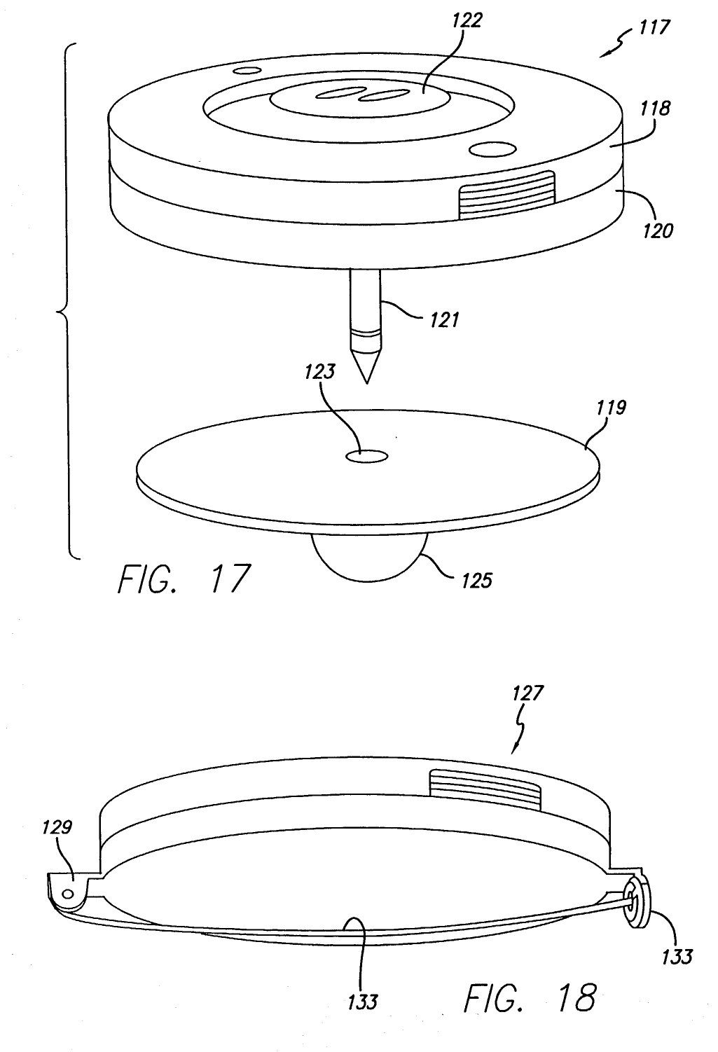

FIG. 17 is a perspective view of an alternate embodiment of the invention in the form of a pin/clip type arrangement. The figure shows a housing unit 117 containing all of the electronic functional components of the GPS Children Locator Device, and a separate spring clip 119. The housing unit 117 may be a unitary housing or a two-piece housing comprising an upper housing 118 similar to upper housing 3, and a lower housing 120 similar to lower housing 5 connected together has hereinbefore described. In either version, an emergency button & microphone arrangement 122 operates in the same manner as the emergency button & microphone arrangement 25 described herein.

In the embodiment of FIG. 17, the housing unit 117 is provided with a thin piercing pin 121 which snap fits into a spring clip 119, whereby a thin sheet of material can be captured between the housing unit 117 and the spring clip 119. The coupling between the housing unit 117 and spring clip 119 is similar to that commonly used to fit an earring to a pierced ear or an emblem to a suit or hat. In this light, it will be appreciated that the housing unit 117 can be released from the spring clip 119 by pressing spring tabs 125, again likened to the operation of an earring and spring clip arrangement.

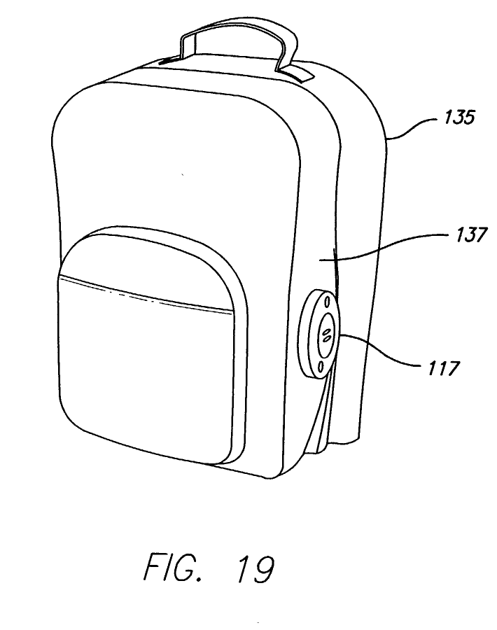

FIG. 18 is a perspective view of yet another embodiment of the invention showing a housing unit 127 having characteristics similar to housing unit 117 shown in FIG. 17, but with a pin hinge 129 fixed to one side of the housing unit 127, and a pin-lock mechanism 133 fixed to the opposite side of the housing unit 127. A piercing pin 131, similar to that of a decorative jewelry pin, or broach, is pivotable in hinge 129 and, after passing through a thin piece of clothing, is latched in the pin-lock mechanism 133 in a manner well known in the jewelry industry.

FIG. 19 is a perspective view of a backpack 135 upon which an embodiment of the invention, such as those shown in FIGS. 17 or 18, is secured to the side 137 of the backpack 135. In the example shown, the embodiment of the invention is in the form of the pin/clip embodiment 117 shown in FIG. 17.

While only certain embodiments of the invention have been set forth above, alternative embodiments and various modifications will be apparent from the above description and the accompanying drawing to those skilled in the art. These and other alternatives are considered equivalents and within the spirit and scope of the present invention.

What is claimed is:

1. A transceiver device for use in a system for locating persons, especially children, or objects, said transceiver device comprising:
an upper housing; and
a lower housing; wherein
said upper and lower housings comprise, respectively, first and second attachment members cooperating to removably attach said upper housing to said lower housing and securely capture a thin piece of material therebetween.

2. The transceiver device as claimed in claim 1, wherein:
one of said upper and lower housings comprises a pin-like projection defining said first attachment member; and
the other of said upper and lower housings comprises a receptacle, defining said second attachment member, for releasably retaining said pin-like projection therein.

3. The transceiver device as claimed in claim 2, wherein:
said pin-like projection has a pointed end for piercing through a thin piece of material before entering into and being releasably retained by said receptacle.

4. The transceiver device as claimed in claim 2, wherein:
said upper housing comprises a battery compartment for receiving and retaining a battery;
said lower housing comprises transceiver electronics; and
said pin-like projection and said receptacle, together, comprise an electrical conductor arrangement for conducting electrical currents between said upper housing and said lower housing.

5. The transceiver device as claimed in claim 4, wherein:
said transceiver electronics comprises a GPS receiver; and
said lower housing comprises an antenna electrically coupled to said GPS receiver.

6. The transceiver device as claimed in claim 4, wherein:
said transceiver electronics comprises a wireless cellular packet transmitter module; and
said lower housing further comprises a wireless cellular packet transmitter module antenna.

7. The transceiver device as claimed in claim 5, wherein:
said transceiver electronics comprises a wireless cellular packet transmitter module; and
said antenna is electrically coupled to said wireless cellular packet transmitter module to function as a wireless cellular packet transmitter module antenna.

8. The transceiver device as claimed in claim 1, wherein:
said upper housing comprises an emergency button which, when activated by a wearer of the transceiver device pressing said button, activates said wireless cellular packet transmitter module.

9. The transceiver device as claimed in claim 8, wherein:
said upper housing comprises a microphone electronically coupled to said wireless cellular packet transmitter module, said microphone permitting voice and ambient sound transmission via said wireless cellular packet transmitter module when activated.

10. The transceiver device as claimed in claim 4, wherein:
said upper housing comprises a battery level indicator, electronically coupled to a battery contained in said battery compartment, for displaying the status of the available battery power.

11. The transceiver device as claimed in claim 2, wherein:
said upper housing comprises a pin-lock indicator, electronically coupled to said pin-like projection and said receptacle, for displaying when the pin-like projection is securely seated in said receptacle.

12. The transceiver device as claimed in claim 2, wherein:
said pin-like projection has a cylindrical main body portion with an annular groove formed around its periphery; and
said receptacle has a cylindrical interior and comprises an internal clip resiliently projecting inwardly of said cylindrical interior, said clip engaging said annular groove of said pin-like projection for releasably locking said pin-like projection to said receptacle.

13. The transceiver device as claimed in claim 2, wherein:
said pin-like projection has a cylindrical main body portion with external screw threads formed on its periphery;
said receptacle has a cylindrical opening therein with internal screw threads formed on its interior; and
said external screw threads are configured and sized to mate with said internal screw threads for releasably fixing said pin-like projection in said receptacle.

14. The transceiver device as claimed in claim 13, wherein:
said pin-like projection body portion has a free distal end;
said receptacle has a proximal end comprising a surface at least partially closing said opening and functioning as a stop for said free distal end, limiting the extent said pin-like projection body portion can enter said receptacle opening, thereby positioning said pin-like projection at a predetermined axial position relative to said receptacle opening.

15. The transceiver device as claimed in claim 4, wherein said electrical conductor arrangement comprises:
a plurality of electrical conductor paths formed on the outer periphery of said pin-like projection body portion; and
a like plurality of electrical contacts formed on the interior of said receptacle; whereby
said electrical conductor paths are aligned with, and are in electrical contact with, respective ones of said electrical contacts when said pin-like projection attains a predetermined axial position with said receptacle.

16. The transceiver device as claimed in claim 12, wherein:
said annular groove and said internal clip are sized and configured so as to allow for a secure but releasable locking action between said pin-like projection and said receptacle when accommodating thin pieces of material of varying thicknesses.

17. The transceiver device as claimed in claim 4, wherein:
said upper housing comprises a cap for covering said battery and retaining said battery in said battery compartment.

18. A transceiver device for use in a system for locating persons, especially children, or objects, said transceiver device comprising:
a housing unit including a battery, a GPS receiver, a wireless cellular packet transmitter module, and an antenna coupled to said GPS receiver and to said wireless cellular packet transmitter module;
a piercing pin affixed to said housing unit; and
a separate spring clip; whereby
said piercing pin is shaped and configured to snap into and latch with said spring clip with a thin sheet of material captured therebetween.

19. A transceiver device for use in a system for locating persons, especially children, or objects, said transceiver device comprising:
a housing unit including a battery, a GPS receiver, a wireless cellular packet transmitter module, and an antenna coupled to said GPS receiver and to said wireless cellular packet transmitter module;
a piercing pin hinged to said housing unit; and
a pin-lock mechanism affixed to said housing unit; whereby
said piercing pin is shaped and configured to extend into and latch with said pin-lock mechanism, with a thin sheet of material captured therebetween said piercing pin and said housing unit.

20. The transceiver device as claimed in claim 18, wherein:
said housing unit comprises an emergency button which, when activated by a wearer of the transceiver device pressing said button, activates said wireless cellular packet transmitter module.

21. The transceiver device as claimed in claim 19, wherein:
said housing unit comprises an emergency button which, when activated by a wearer of the transceiver device pressing said button, activates said wireless cellular packet transmitter module.
